(19) United States
(12) Patent Application Publication
(10) Pub. No.: US 2022/0368143 A1
(43) Pub. Date: Nov. 17, 2022

(54) CONTROL METHOD AND UPDATE METHOD OF ELECTRONIC INK DISPLAY APPARATUS, AND RELATED DEVICES AND SYSTEM

(71) Applicant: BOE TECHNOLOGY GROUP CO., LTD., Beijing (CN)

(72) Inventors: Xiaohong WANG, Beijing (CN); Xin LI, Beijing (CN)

(73) Assignee: BOE TECHNOLOGY GROUP CO., LTD., Beijing (CN)

(21) Appl. No.: 17/764,929

(22) PCT Filed: Mar. 19, 2021
(86) PCT No.: PCT/CN2021/081808

§ 371 Date: Mar. 29, 2022

(30) Foreign Application Priority Data
Mar. 19, 2020 (CN) 202010197780.9

(51) Int. Cl. H02J 7/00; H04B 5/00

(52) U.S. Cl. CPC H02J 7/00034; H02J 7/005; H04B 5/0031; H04B 5/0081

(57) ABSTRACT

A control method of an electronic ink display apparatus, which is applied to a terminal equipment. The method includes: charging the electronic ink display device; outputting charging state prompt information, and after the terminal device establishes a wireless communication connection with the electronic ink display device, receiving a data update instruction and sending target update content to the electronic ink display device. Outputting the charging state prompt information includes: outputting charging completion prompt information in response to a completion of the charging of the electronic ink display device.

### CROSS-REFERENCE TO RELATED APPLICATIONS

This application is a national phase entry under 35 USC 371 of International Patent Application No. PCT/CN2021/081808, filed on Mar. 19, 2021, which claims priority to Chinese Patent Application No. 202010197780.9, filed on Mar. 19, 2020, which are incorporated herein by reference in their entirety.

### TECHNICAL FIELD

The present application relates to the field of data processing technologies, and in particular, to a control method and an update method of an electronic ink display apparatus, related devices and a system.

### BACKGROUND

Electronic ink display apparatuses (also called electronic ink screens) include a screen that uses electronic ink. Like most traditional ink, electronic ink may be printed onto many surfaces, such as curved plastic, polyester film, paper, and cloth. Compared with traditional paper, the electronic ink display apparatus can display different images like a calculator or a mobile phone when it is powered on. Electronic ink display apparatuses have low power consumption, and contents displayed thereon look like printed text, which may make eyes relaxed.

### SUMMARY

In an aspect, a control method of an electronic ink display apparatus is provided. The method is applied to a terminal equipment, and the method includes: charging the electronic ink display apparatus, outputting charging state prompt information, and after the terminal equipment establishes a wireless communication connection with the electronic ink display apparatus, receiving a data update instruction and sending target update content to the electronic ink display apparatus. Outputting the charging state prompt information includes: outputting charging completion prompt information in response to a completion of the charging of the electronic ink display apparatus.

In some embodiments, charging the electronic ink display apparatus includes: wirelessly charging the electronic ink display apparatus in response to establishment of the wireless communication connection of the terminal equipment to the electronic ink display apparatus; or, wirelessly charging the electronic ink display apparatus in response to the electronic ink display apparatus entering a wireless field provided by the terminal equipment.

In some embodiments, the control method of the electronic ink display apparatus further includes: obtaining charging information of the electronic ink display apparatus. Outputting the charging state prompt information includes: outputting the charging state prompt information according to the charging information.

In some embodiments, receiving the data update instruction includes: receiving a click instruction of a data update button displayed on the terminal equipment; and if the charging state prompt information is used for indicating that the charging of the electronic ink display apparatus is completed, recognizing the click instruction as the data update instruction. The control method of the electronic ink display apparatus further includes: if the charging state prompt information is used for indicating that the charging of the electronic ink display apparatus is not completed, not recognizing the click instruction as the data update instruction.

In some embodiments, charging the electronic ink display apparatus includes: charging the electronic ink display apparatus through a near field communication technology. Sending the target update content to the electronic ink display apparatus includes: sending the target update content to the electronic ink display apparatus through another near field communication technology.

In some embodiments, the control method of the electronic ink display apparatus further includes: obtaining an identification of the electronic ink display apparatus. Sending the target update content to the electronic ink display apparatus includes: sending the target update content to the electronic ink display apparatus according to the identification of the electronic ink display apparatus.

In some embodiments, after receiving the data update instruction and sending the target update content to the electronic ink display apparatus, the control method of the electronic ink display apparatus further includes at least one of the following steps: receiving a stop transmission instruction to stop sending the target update content to the electronic ink display apparatus, and outputting stop transmission prompt information; receiving a retransmission instruction, resending the target update content to the electronic ink display apparatus and outputting retransmission prompt information; and receiving a suspension transmission instruction to suspend the sending of the target update content to the electronic ink display apparatus, and outputting suspension transmission information.

In some embodiments, the control method of the electronic ink display apparatus further includes: after a transmission of the target update content is completed and before an update of the electronic ink display apparatus is completed, outputting update incompletion prompt information and charging the electronic ink display apparatus.

In some embodiments, the control method of the electronic ink display apparatus further includes: outputting update completion prompt information in response to a completion of an update of the electronic ink display apparatus.

In some embodiments, the control method of the electronic ink display apparatus further includes: obtaining information about the connection between the terminal equipment and the electronic ink display apparatus; and outputting connection state prompt information according to the information about the connection.

In some embodiments, the control method of the electronic ink display apparatus further includes: receiving an instruction for a connection to at least one electronic ink display apparatus; scanning at least one electronic ink display apparatus within a predetermined range; and establishing a wireless communication connection with at least one electronic ink display apparatus within the predetermined range.

In another aspect, an update method of an electronic ink display apparatus is provided, which includes: performing charging through a terminal equipment; receiving target update content sent by the terminal equipment after the electronic ink display apparatus establishes a wireless communication connection with the terminal equipment and charging of the electronic ink display apparatus is completed; and refreshing display content according to the target update content.

In some embodiments, the update method of the electronic ink display apparatus further includes at least one of the following steps: feeding back connection information to the terminal equipment; feeding back charging information to the terminal equipment after the electronic ink display apparatus establishes the wireless communication connection with the terminal equipment.

In some embodiments, after the electronic ink display apparatus establishes the wireless communication connection with the terminal equipment, feeding backing the charging information to the terminal equipment includes: after the electronic ink display apparatus establishes the wireless communication connection with the terminal equipment, feeding backing a charging completion message to the terminal equipment in response to the completion of the charging of the electronic ink display apparatus. Feeding back the connection information to the terminal equipment includes: feeding back a connection success message to the terminal equipment in response to establishing the connection with the terminal equipment.

In some embodiments, performing the charging through the terminal equipment includes: after the electronic ink display apparatus enters a wireless field provided by the terminal equipment, performing wireless charging through the wireless field provided by the terminal equipment in response to the establishment of the wireless communication connection of the electronic ink display apparatus to the terminal equipment; or, performing wireless charging through the wireless field provided by the terminal equipment after entering the wireless field provided by the terminal equipment.

In some embodiments, performing the charging through the terminal equipment includes: performing charging through the terminal equipment based on a near field communication technology. Receiving the target update content sent by the terminal equipment includes: receiving the target update content sent by the terminal equipment based on another near field communication technology.

In some embodiments, the update method of the electronic ink display apparatus further includes: feeding back an update completion message to the terminal equipment in response to a completion of an update.

In yet another aspect, a terminal equipment is provided. The terminal equipment includes: a first charging and communication device, a first processor, and an output device. The first charging and communication device is configured to charge an electronic ink display apparatus. The first processor is configured to control the output device to output charging state prompt information. Outputting the charging state prompt information includes: outputting charging completion prompt information in response to a completion of the charging of the electronic ink display apparatus. The first charging and communication device is further configured to receive a data update instruction after the terminal equipment establishes a wireless communication connection with the electronic ink display apparatus. The first processor is further configured to control, in response to the data update instruction, the first charging and communication device to send target update content to the electronic ink display apparatus.

In yet another aspect, a terminal equipment is provided. The terminal equipment includes a memory and a processor. The memory stores therein computer programs, and the processor is configured to run the computer programs, so that the terminal equipment performs the control method of the electronic ink display apparatus as described in any of the above embodiments.

In yet another aspect, an electronic ink display apparatus is provided. The electronic ink display apparatus includes: a second charging and communication device, a second processor, and a display device. The second charging and communication device, the second processor, and the display device are configured to perform the update method of the electronic ink display apparatus as described in any of the above embodiments.

In yet another aspect, an electronic ink display apparatus is provided. The electronic ink display apparatus includes: a memory and a processor. The memory stores therein computer programs, and the processor is configured to run the computer programs, so that the electronic ink display apparatus can perform the update method of the electronic ink display apparatus as described in any of the above embodiments.

In yet another aspect, an update system of the electronic ink display apparatus is provided. The update system includes the terminal equipment as described in any of the above embodiments, and the electronic ink display apparatus includes a second charging and communication device, a second processor, and a display device. The second charging and communication device is configured to perform the charging through the terminal equipment, and receive the target update content sent by the terminal equipment after the electronic ink display apparatus establishes the wireless communication connection with the terminal equipment and the charging of the electronic ink display apparatus is completed. The second processor is configured to control, according to the target update content, the display device to refresh display content.

In yet another aspect, a non-transitory computer-readable storage medium is provided. The computer-readable storage medium stores computer program instructions that, when executed on a computer, cause the computer to perform the control method of the electronic ink display apparatus as described in any of the above embodiments or perform the update method of the electronic ink display apparatus as described in any of the above embodiments.

### BRIEF DESCRIPTION OF THE DRAWINGS

In order to describe technical solutions in the present disclosure more clearly, the accompanying drawings to be used in some embodiments of the present disclosure will be introduced briefly below. However, the accompanying drawings to be described below are merely accompanying drawings of some embodiments of the present disclosure, and a person of ordinary skill in the art can obtain other drawings according to these drawings. In addition, the accompanying drawings in the following description may be regarded as schematic diagrams, and are not limitations on actual sizes of products, actual processes of methods and actual timings of signals involved in the embodiments of the present disclosure.

FIG. 1 is an architecture diagram of an update system of an electronic ink display apparatus, in accordance with some embodiments of the present disclosure;

FIG. 2 is a structural diagram of a terminal equipment or an electronic ink display apparatus, in accordance with some embodiments of the present disclosure;

FIG. 3 is a structural diagram of a terminal equipment, in accordance with some embodiments of the present disclosure;

FIG. 4 is a structural diagram of a near field communication (NFC) module, in accordance with some embodiments of the present disclosure;

FIG. 5 is a structural diagram of an electronic ink display apparatus, in accordance with some embodiments of the present disclosure;

FIG. 6 is a flow diagram of a control method of an electronic ink display apparatus, in accordance with some embodiments of the present disclosure;

FIG. 7 is a schematic diagram showing a first interface displayed on a terminal equipment, in accordance with some embodiments of the present disclosure;

FIG. 8 is a schematic diagram showing a second interface displayed on a terminal equipment, in accordance with some embodiments of the present disclosure;

FIG. 9 is a schematic diagram showing a third interface displayed on a terminal equipment, in accordance with some embodiments of the present disclosure;

FIG. 10 is a schematic diagram showing a fourth interface displayed on a terminal equipment, in accordance with some embodiments of the present disclosure; and

FIG. 11 is a structural diagram of an electronic ink display apparatus, in accordance with some embodiments of the present disclosure.

### DETAILED DESCRIPTION

Technical solutions in some embodiments of the present disclosure will be described clearly and completely below with reference to the accompanying drawings. However, the described embodiments are merely some but not all embodiments of the present disclosure. All other embodiments obtained on a basis of the embodiments of the present disclosure by a person of ordinary skill in the art shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or examples(s). In addition, the specific features, structures, materials, or characteristics may be included in any one or more embodiments or examples in any suitable manner.

Hereinafter, the terms “first” and “second” are only used for descriptive purposes, and are not to be construed as indicating or implying relative importance or implicitly indicating the number, the sequence or the importance of indicated technical features. Thus, a feature defined with “first” and “second” may explicitly or implicitly include one or more of the features. In the description of the embodiments of the present disclosure, the term “a plurality of/the plurality of” means two or more unless otherwise specified.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

In the description of some embodiments, terms such as “coupled” and “connected” and their derivatives may be used. For example, the term “connected” may be used when describing some embodiments to indicate that two or more components are in direct physical or electrical contact with each other. For another example, the term “coupled” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the content herein.

As used herein, the term “if”, depending on the context, is optionally construed as “when”, “in a case where”, “in response to determining”, or “in response to detecting”. Similarly, depending on the context, the phrase “if it is determined that” or “if it is detected” is optionally construed as “in a case where it is determined that” or “in response to determining that” or “in a case where detecting that” or “in response to detecting that”.

The use of the phrase “applicable to” or “configured to” herein means an open and inclusive language, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values exceeding those stated.

Generally, an update of display content of an electronic ink display apparatus may be achieved through an interaction between a terminal equipment and the electronic ink display apparatus. However, in a process of sending content to be displayed to the electronic ink display apparatus by the terminal equipment, the transmission may fail due to insufficient power of the electronic ink display apparatus.

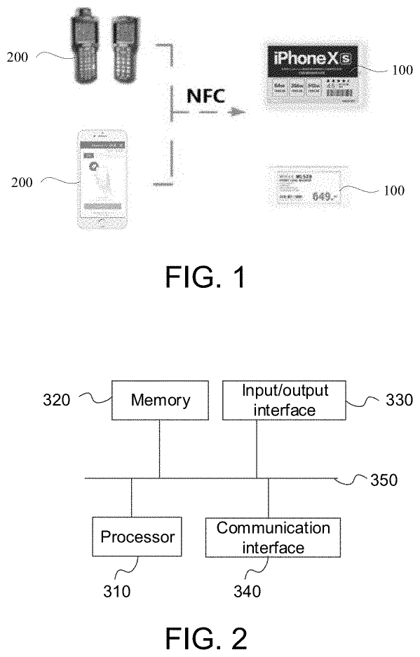

In order to solve this problem, referring to FIG. 1, some embodiments of the present disclosure provide an update system of an electronic ink display apparatus. The update system includes the electronic ink display apparatus 100 and a terminal equipment 200, and a data interaction is achieved therebetween through wireless communication. In some embodiments, a communication connection between the terminal equipment 200 and the electronic ink display apparatus 100 may be established based on a near field communication (NFC) technology (also called short distance wireless communication technology). Of course, other wireless communication methods may also be adopted to achieve the data interaction, which is not limited here.

The terminal equipment 200 is configured to control the electronic ink display apparatus 100 to update display content (e.g., displayed images). In addition, the terminal equipment 200 may charge the electronic ink display apparatus 100. That is, the terminal equipment 200 provides energy required for the electronic ink display apparatus 100 to update the display content. The terminal equipment 200 may be a dedicated device, or a mobile terminal with the above control functions, such as a mobile phone, a personal digital assistant (PDA), or a tablet personal computer (tablet PC). For example, the mobile terminal may achieve the update and management of the electronic ink display apparatus by installing software (e.g., an application (APP)) corresponding to the electronic ink display apparatus.

The electronic ink display apparatus 100 may also be referred to as an electronic ink screen, which may be applied to various scenarios. For example, the electronic ink display apparatuses 100 may be electronic readers, smart tags (also called electronic tags), electronic timepieces (e.g., electronic watches), thermometers, bus stop signs, and gas price tags at a gas station. The smart tags may include an electronic price tag or a product description tag that may be placed on a shelf in supermarket, a convenience store, a pharmacy or the like, a luggage tag, and a drug tag on drug packaging.

Referring to FIG. 2, the terminal equipment 200 is an electronic device, and the electronic device may include a processor 310, a memory 320, an input/output interface 330, a communication interface 340, and a bus 350. The processor 310, the memory 320, the input/output interface 330, and the communication interface 340 are communicatively connected to each other inside the electronic device through the bus.

The processor 310 may be a general central processing unit (CPU), a microcontroller unit (MCU), an application specific integrated circuit (ASIC), a logic device, or one or more integrated circuits for executing related computer programs or implementing at least one step in some embodiments of the present disclosure. The CPU may be a single-core processor or a multi-core processor (multi-core CPU). The processor herein may refer to one or more devices, circuits or processing cores for processing data (e.g., computer program instructions).

The memory 320 may be a read only memory (ROM), a random access memory (RAM), a static storage device, a dynamic storage device, or the like. The memory 320 may store an operating system and other application programs. When technical solutions provided by the embodiments of the present disclosure are implemented in software or firmware, related computer programs are stored in the memory, and are called and executed by the processor 310.

The input/output interface 330 is used to be connected to an input/output device to achieve input/output of information. An input/output device may be configured in the equipment as a component (not shown in the FIG. 2), or may be externally connected to the equipment to provide corresponding functions. The input device may include a keyboard, a mouse, a touch screen, a microphone, various sensors, etc., and the output device may include a display device (e.g., a display), a speaker, a vibrator, an indicator, etc.

The communication interface 340 is used to be connected to a communication device (not shown in the figure) to achieve communication interaction between the terminal equipment and other devices. The communication device may achieve communication in a wired manner (e.g., a universal serial bus (USB), or a network cable), or in a wireless manner (e.g., Wi-Fi, Bluetooth, or NFC).

The bus 350 includes a path for transmitting information between various components of the equipment (e.g., the processor 310, the memory 320, the input/output interface 330 and the communication interface 340).

It will be noted that, only the processor 310, the memory 320, the input/output interface 330, the communication interface 340, and the bus 350 are shown in the equipment; however, in a specific implementation process, the equipment may further include other components necessary for normal operation. In addition, those skilled in the art can understand that the equipment may also only include components necessary to achieve the solutions provided in the embodiments of the present specification, and it is not necessary for the equipment to include all the components shown in this figure.

Referring to FIG. 3, embodiments of the present disclosure provide a terminal equipment 200, which includes a first charging and communication device 210, a first processor 220, and an output device 230.

The first charging and communication device 210 is configured to charge the electronic ink display apparatus and perform wireless communication with the electronic ink display apparatus, for example, to perform a data/signaling (e.g., instruction) interaction. For example, the first charging and communication device 210 may include a charging device and a communication device. The communication device may be a communication device connected to the communication interface 340 in FIG. 2. For example, the communication device may be a wireless communication device (e.g., including a wireless communication chip) or an NFC module (also called an NFC device). The charging device may provide energy for the electronic ink display apparatus in a wired or wireless manner. For example, the charging device may include a charging interface (e.g., a USB interface or a USB Type C interface), a wireless charging device (e.g., an NFC module), etc. The charging device and the communication device may be two separate devices, or share part of components.

For example, referring to FIG. 4, the NFC module may include an NFC chip and a control circuit coupled to each other. The control circuit may include at least one NFC coil (also called an NFC antenna coil).

In an example, the first charging and communication device 210 may include two first NFC modules. One first NFC module may be configured to charge the electronic ink display apparatus. For example, the first NFC module may include an NFC chip and an NFC charging coil coupled to each other, and the NFC chip generates an NFC magnetic field (e.g., an NFC high frequency magnetic field) through the NFC charging coil. The other first NFC module may be configured to perform wireless communication with the electronic ink display apparatus for the data/signaling interaction. For example, this first NFC module may include an NFC chip and an NFC communication coil coupled to each other, and the NFC chip sends/receives NFC signals (e.g., data or signaling) through the NFC communication coil. A charging function and a wireless communication function of the terminal equipment may be used simultaneously, or may not be used simultaneously as needed.

In another example, the first charging and communication device 210 may include one first NFC module, and the first NFC module includes an NFC chip, and an NFC charging coil and an NFC communication coil that are coupled to the NFC chip. In a case where the first NFC module charges the electronic ink display apparatus, the NFC chip generates the NFC magnetic field through the NFC charging coil. In a case where the first NFC module performs the wireless communication with the electronic ink display apparatus, the NFC chip sends/receives NFC signals through the NFC communication coil. The charging function and the wireless communication function of the terminal equipment may be used simultaneously, or may not be used simultaneously as needed.

In yet another example, the first charging and communication device 210 may include one first NFC module, and the first NFC module includes an NFC chip and an NFC coil coupled to the NFC chip. In a case where the first NFC module charges the electronic ink display apparatus, the NFC chip generates an NFC magnetic field through the NFC coil. In a case where the first NFC module performs the wireless communication with the electronic ink display apparatus, the NFC chip sends/receives NFC signals through the NFC coil. The charging function and the wireless communication function of the terminal equipment are not used simultaneously.

As for the description of the first processor 220, reference may be made to the description of the processor 310 in FIG. 2. The first processor 220 may execute computer program instructions stored in the memory, so that the terminal equipment performs a control method of the electronic ink display apparatus in any of the embodiments of the present disclosure.

As for the description of the output device 230, reference may be made to the description of the output device to which the input/output interface 330 in FIG. 2 is connected. For example, the output device may be a first display device configured to display an image (i.e., a picture). The first display device may be a display or a touch display. The touch display includes a display screen and a touch sensor.

In some embodiments, embodiments of the present disclosure further provide an electronic ink display apparatus, which is an electronic device. As for a structure of the electronic ink display apparatus, reference may be made to the structure shown in FIG. 2.

In some other embodiments, referring to FIG. 5, embodiments of the present disclosure provide an electronic ink display apparatus 100, which includes a second charging and communication device 110, a second processor 120, and a display device 130. In order to distinguish the display device 130 from the above first display device, the display device 130 may be referred to as a second display device.

The second charging and communication device 110 is configured to perform charging through the terminal equipment, and perform a wireless communication with the terminal equipment, for example, performing a data/signaling (e.g., instruction) interaction. For example, the second charging and communication device 110 may include a charging device, a communication device, and an energy storage device. The communication device may be a communication device to which the communication interface 340 in FIG. 2 is connected. For example, the communication device may be a wireless communication device (e.g., including a wireless communication chip), such as an NFC module (also called an NFC device). The charging device may provide a power supply path to the electronic ink display apparatus in a wired or wireless manner. For example, the charging device may include a charging interface (e.g., a USB interface or a USB Type C interface), a wireless charging device (e.g., an NFC module), etc. The energy storage device is coupled to the charging device, and is configured to store energy obtained through the charging device. The energy storage device may be, for example, a capacitor. In an example, as for a structure of the NFC module, reference may be made to the structure shown in FIG. 4, and the energy storage device may be integrated in the NFC chip. In another example, the energy storage device may be separated from the NFC chip.

In an example, the second charging and communication device 110 may include two second NFC modules. One second NFC module may be configured to perform charging through the terminal equipment. For example, the second NFC module may include an NFC chip and an NFC charging coil coupled to each other, and the NFC charging coil is configured to receive an NFC magnetic field (e.g., an NFC high frequency magnetic field) generated by the terminal equipment. The NFC chip is configured to store electrical energy (e.g., the high-frequency alternating current) obtained through the NFC magnetic field in the energy storage device. The other second NFC module may be configured to perform wireless communication with the terminal equipment for the data/signaling interaction. For example, this second NFC module may include an NFC chip and an NFC communication coil coupled to each other, and the NFC chip sends/receives NFC signals (e.g., data or signaling) through the NFC communication coil. The charging function and the wireless communication function of the electronic ink display apparatus may be used simultaneously, or may not be used simultaneously as needed.

In another example, the second charging and communication device 110 may include one second NFC module, and the second NFC module includes an NFC chip, and an NFC charging coil and an NFC communication coil that are coupled to the NFC chip. The NFC chip and the NFC charging coil are configured to achieve the charging function of the electronic ink display apparatus, and the NFC chip and the NFC communication coil are configured to achieve the wireless communication function of the electronic ink display apparatus.

In yet another example, the second charging and communication device 110 may include one second NFC module, and the second NFC module includes an NFC chip and an NFC coil coupled to the NFC chip. The NFC chip and the NFC coil are configured to achieve the charging function and the wireless communication function of the electronic ink display apparatus.

The second processor 120 may be referred to the description of the processor 310 in FIG. 2. The second processor 120 may execute computer program instructions stored in the memory, so that the electronic ink display apparatus performs an update method of the electronic ink display apparatus in any of the embodiments of the present disclosure.

The display device 130 is an electronic ink display panel. The electronic ink display panel can display images under a control of the second processor 120. For example, the electronic ink display panel may include two substrates disposed opposite to each other, and an electronic ink layer disposed between the two substrates.

Based on the update system of the electronic ink display apparatus, some embodiments of the present disclosure provide a control method of the electronic ink display apparatus, which is applied to the terminal equipment. As shown in FIG. 6, the control method of the electronic ink display apparatus may include the following steps.

In S101 (optionally), the terminal equipment obtains target update content.

A method of obtaining the target update content is not limited here. The target update content may be obtained through a network or generated locally. Before the target update content is obtained, prompt information of adding update content may also be displayed.

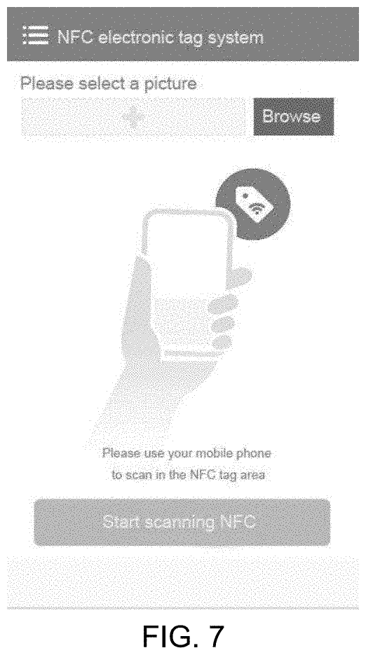

For example, the control method of the electronic ink display apparatus may be achieved by means of an APP installed in the terminal equipment. The obtaining process may be started by means of a button for obtaining the target update content in the APP. For example, after the APP is opened, referring to FIG. 7, a first interface is displayed on the terminal equipment, and the first interface includes a control of adding update content, and prompt information of adding update content. The prompt information of adding update content may be words of “Please select a picture” to prompt the user to select a picture as the target update content. The control of adding update content may be an input box or a button below or above the words of “Please select a picture”, and is shown with a “+” sign in FIG. 7, so as to prompt the user to click the “+” sign to select content. The control of adding update content may also be a “Browse” button next to the “+” sign, so as to prompt the user to click the “Browse” button to select a local picture as the target update content, or the like. In response to an operation of the user on the control of adding update content, the terminal equipment obtains target update content determined by the user. The “+” sign or the “Browse” button in the first interface may be clicked by the user, so that the terminal equipment is controlled to obtain the target update content.

For example, before the step of obtaining the target update content, the control method of the electronic ink display apparatus may further include: outputting unconnectable prompt information to prompt the user that the target update content is being obtained and a connection to the electronic ink display apparatus is not allowed. For example, after the step of obtaining the target update content, the control method of the electronic ink display apparatus may further include: outputting connectable prompt information to prompt the user that the target update content has been obtained, and a connection to the electronic ink display apparatus to be updated may be started. Both the unconnectable prompt information and the connectable prompt information may be displayed on the first display device of the terminal equipment.

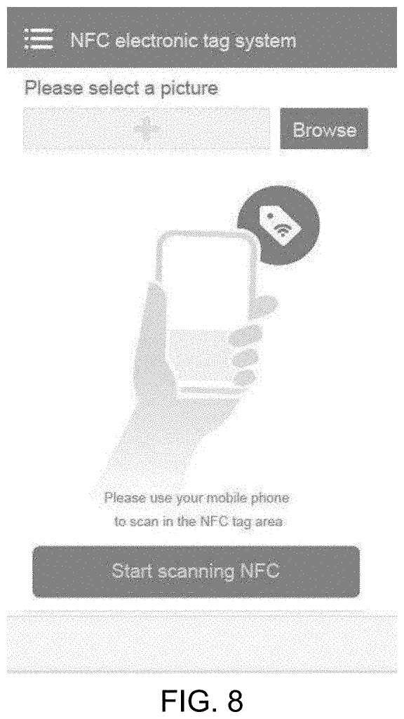

A communication connection control may be displayed on the first display device of the terminal equipment, and corresponding prompts may be shown to the user by controlling a state of the communication connection control. Referring to FIG. 7, when the connection of the terminal equipment to the electronic ink display apparatus is not allowed, the communication connection control on the first interface is in an inoperable state. For example, the button for starting an establishment of communication connection in FIG. 7 is grayed out. The button for starting the establishment of communication connection is a button of “Start scanning NFC” in FIG. 7. When the user clicks the button, the terminal equipment makes no response. That is, the unconnectable prompt information is that the button of “Start scanning NFC” is grayed out. Referring to FIG. 8, when the connection of the terminal equipment to the electronic ink display apparatus is allowed, the communication connection control on a second interface shown in FIG. 8 is in an operable state. For example, the button of “Start scanning NFC” is lightened (e.g., the button is blue), which allows the user to click the button, so that the terminal equipment starts scanning the electronic ink display apparatus(es) to which it can be connected. In this way, by outputting different prompt information, the user can immediately see the current progress, so as to well control the entire update process.

In S102, the terminal equipment charges the electronic ink display apparatus, and establishes a wireless communication connection with the electronic ink display apparatus.

The terminal equipment may charge the electronic ink display apparatus in a wireless charging manner. For example, the terminal equipment may charge the electronic ink display apparatus based on an NFC technology. In this way, the electronic ink display apparatus may be charged by the terminal equipment without being provided with a power supply, which helps to simply an internal structure of the electronic ink display apparatus, and thus reduces the production cost of the electronic ink display apparatus.

In some embodiments, S102 may include: wirelessly charging, by the terminal equipment, the electronic ink display apparatus in response to the electronic ink display apparatus entering a wireless field (e.g., a magnetic field) provided by the terminal equipment. At the same time when the charging is started, or after the charging is started and before the charging is completed, or after the charging is completed, the electronic ink display apparatus establishes the wireless communication connection with the terminal equipment.

For example, after opening the NFC function, the terminal equipment can generate a magnetic field (e.g., a radio frequency (RF) field) through the first NFC module shown in FIG. 3 to transmit electromagnetic energy to the electronic ink display apparatus. In a case where a distance between the electronic ink display apparatus and the terminal equipment is close, the second NFC module shown in FIG. 5 can receive the electromagnetic energy and convert the electromagnetic energy into electrical energy, and the electrical energy may be stored in the energy storage device.

In some other embodiments, S102 may include: wirelessly charging, by the terminal equipment, the electronic ink display apparatus in response to an establishment of the wireless communication connection between the terminal equipment and the electronic ink display apparatus.

Firstly, the terminal equipment establishes the wireless communication connection with the electronic ink display apparatus.

For example, when the electronic ink display apparatus operates after being powered on, device information of the electronic ink display apparatus may be sent to the terminal equipment through the second NFC module shown in FIG. 5, and the terminal equipment obtains (i.e., receives) information (or called the device information) of the electronic ink display apparatus through the first NFC module shown in FIG. 3. The information of the electronic ink display apparatus may include an identification of the electronic ink display apparatus, and may further include a type of the NFC module (e.g., a type of the NFC chip), and the like. The identification of the electronic ink display apparatus may include an identity document (ID) of the electronic ink display apparatus, and/or an ID of the NFC chip.

The terminal equipment establishes the communication connection with the electronic ink display apparatus according to the received identification of the electronic ink display apparatus and an NFC communication protocol, so as to achieve the data/signaling interaction between the electronic ink display apparatus corresponding to the identification and the terminal equipment. A carrier frequency of a wave carrying a communication signal is 13.56 MHz, and the distance between the electronic ink display apparatus and the terminal equipment is less than or equal to 10 cm (e.g., 5 cm), so as to ensure the establishment of the communication connection between the apparatus and the equipment and achieve normal communication.

Generally, the NFC module has three operating modes, i.e., a point-to-point operating mode, a reader/writer operating mode, and a card emulation operating mode. For example, the terminal equipment may identify a type of the second NFC module in the electronic ink display apparatus to determine its operating mode, so that the first NFC module of the terminal equipment and the second NFC module of the electronic ink display apparatus can achieve the subsequent data/signaling interaction in this operating mode.

In some embodiments, the control method of the electronic ink display apparatus further includes: receiving an instruction for connection to the electronic ink display apparatus, scanning electronic ink display apparatus(es) within a predetermined range; and establishing a wireless communication connection with at least one electronic ink display apparatus within the predetermined range.

For example, the control method of the electronic ink display apparatus may be achieved by means of an APP installed in the terminal equipment, and the establishment of the communication connection may be started by means of a communication connection control in the APP. The user may operate the communication connection control on the first interface, and the terminal equipment starts to receive information sent by the electronic ink display apparatus to establish the communication connection. For example, when the display interface jumps to the second interface shown in FIG. 8, the user can click the button of “Start scanning NFC” to start the establishment of the communication connection.

The predetermined range may be set as needed, or adopt a default setting, and the specific range may be set according to specific situations. For example, if the communication connection is established through NFC, the predetermined range may be a range that allows the first NFC module in the terminal equipment to receive information. For example, the distance between the electronic ink display apparatus and the terminal equipment is less than or equal to 10 cm.

In an example, after several electronic ink display apparatuses are scanned, at least one (e.g., one) electronic ink display apparatus that needs to establish the communication connection is determined according to a user instruction.

In another example, after several electronic ink display apparatuses are scanned, the terminal equipment establishes connections with a predetermined number of electronic ink screens, within a predetermined range, whose signal intensities comply with a predetermined intensity requirement. Here, the predetermined intensity requirement is a preset intensity requirement that meets a requirement for establishing the connection, and electronic ink screens whose signal intensities meet the intensity requirement may be connected. The electronic ink screens can be sorted according to strength values from large to small, and the intensity requirement is used for selecting electronic ink screen(s) whose signal intensities are front to establish the connections. The predetermined number here may be preset according to the actual scene needs, or may be preset by the user, which is not limited. For example, if one electronic ink screen needs to be connected, the predetermined number is 1, and the intensity requirement may be that the intensity is the highest. In this way, by scanning electronic ink screen(s) within the predetermined range, an electronic ink screen to be updated may be determined according to a signal intensity standard.

Of course, it is only one implementation manner to determine the electronic ink screen to be updated based on the signal intensity, and other manners may be adopted to determine the electronic ink screen to be updated according to actual conditions, so as to establish the connection thereto. For example, if the ID of the electronic ink screen to be updated is known, the electronic ink screen to be updated may be directly determined based on its ID and the connection thereto may be established without comparing the signal intensities of the electronic ink screens within the predetermined range.

In some embodiments, the control method of the electronic ink display apparatus may further include: obtaining information (also called connection state information) about the connection between the terminal equipment and the electronic ink display apparatus, and outputting connection state prompt information according to the information about the connection. If the terminal equipment is not connected with the electronic ink display apparatus, the connection state information indicates that the connection to the electronic ink display apparatus is not established, and corresponding connection state prompt information is prompt information indicating that the connection is not established. If the terminal equipment is connected with the electronic ink display apparatus, the connection state information indicates that the connection to the electronic ink display apparatus is established, and corresponding connection state prompt information is prompt information indicating that the connection is established. These steps may be performed in the process of establishing the wireless communication connection to the electronic ink display apparatus by the terminal equipment, or may be performed multiple times at a certain time interval after the wireless communication connection is established.

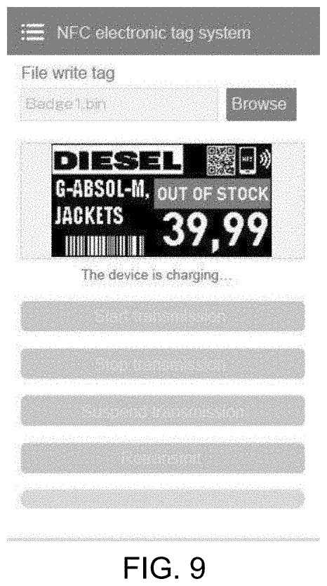

For example, when the connection of the terminal equipment to the electronic ink display apparatus is not established, the first display device of the terminal equipment may display words of “No electronic ink display apparatus is found” as the prompt information indicating that the connection is not established. For another example, when the terminal equipment successfully establishes a connection with an electronic ink display apparatus, a display screen of the terminal equipment may display words of “A connection with an electronic ink display apparatus has been established” as prompt information indicating that the connection is successfully established. Optionally, after the terminal equipment successfully establishes the connection with the electronic ink display apparatus, the terminal equipment may further display the identification (e.g., ID) of the connected electronic ink display apparatus, so that the user determines whether the electronic ink display apparatus that is successfully connected currently is a correct electronic ink display apparatus that needs to be updated. By outputting the prompt information indicating that the connection is not established or the prompt information indicating that the connection is successfully established to prompt the user whether the connection is established successfully, the user may adjust a relative position of the terminal equipment and the electronic ink display apparatus in time. For example, after the terminal equipment establishes the connection with the electronic ink display apparatus, the terminal equipment may display a third interface as shown in FIG. 9 to prompt the user that the connection has been successfully established, so that the user knows a corresponding progress in time.

For example, when there are multiple electronic ink display apparatuses that can be connected, the terminal equipment may display identifications of all the electronic ink display apparatuses that can be connected on the display screen. In this way, the user can select an identification of any electronic ink display apparatus displayed on the terminal equipment. In response to a result selected by the user, the terminal equipment establishes the communication connection with the electronic ink display apparatus selected by the user.

Then, after establishing the wireless communication connection with the electronic ink display apparatus, the terminal equipment wirelessly charges the electronic ink display apparatus connected therewith. As for the wireless charging process for the electronic ink display apparatus, reference may be made to the previous embodiments, which will not be repeated here.

In S103, the terminal equipment outputs charging state prompt information.

S103 may include: outputting charging completion prompt information in response to the completion of charging of the electronic ink display apparatus.

For example, the update of the display content of the electronic ink display apparatus is achieved through running of its internal circuits, and the internal circuits of the electronic ink display apparatus need a certain amount of electricity to start running. An amount of electricity required for the internal circuits to be turned on and to maintain the running for a subsequent period of time is referred to as a rated amount of electricity (or a preset amount of electricity). A value of the rated amount of electricity is related to the internal circuits of the electronic ink display apparatus, which is not limited here. The electronic ink display apparatus stores the amount of electricity obtained from the terminal equipment in the capacitor. When the amount of electricity in the capacitor is not less than the rated amount of electricity, the charging is completed; otherwise, the charging is not completed.

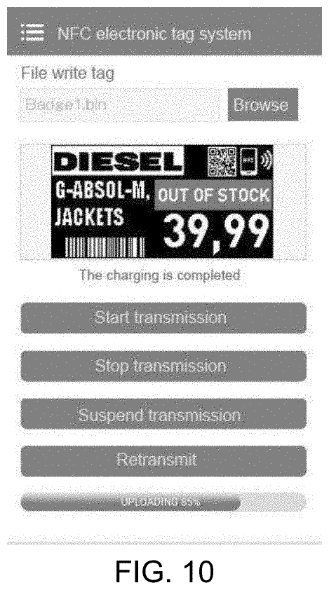

For example, S103 may include: obtaining charging information (also called a charging state) of the electronic ink display apparatus (e.g., after establishing the communication connection with the electronic ink display apparatus, receiving the charging information sent by the electronic ink display apparatus); and outputting the charging state prompt information according to the charging information. When the amount of electricity in the capacitor of the electronic ink display apparatus is less than the rated amount of electricity, the terminal equipment obtains the charging information from the electronic ink display apparatus, which indicates that the electronic ink display apparatus is being charged, and the charging state prompt information output by the terminal equipment is prompt information indicating that the apparatus is being charged. If the amount of electricity in the capacitor of the electronic ink display apparatus is not less than the rated amount of electricity, the terminal equipment obtains the charging information from the electronic ink display apparatus, which indicates that the charging of the electronic ink display apparatus has been completed, and the charging state prompt information output by the terminal equipment is the charging completion prompt information. For example, referring to FIG. 9, if the electronic ink display apparatus is being charged, the third interface displayed on the first display device of the terminal equipment displays words of “The device is being charged . . . ”, or “The charging is not completed, please wait”, etc. as the prompt information indicating that the apparatus is being charged. For another example, referring to FIG. 10, if the charging of the electronic ink display apparatus is completed, a fourth interface displayed on the first display device of the terminal equipment displays words of “The charging is completed” as the charging completion prompt information. When the charging is not completed, the third interface displays the prompt information indicating that the apparatus is being charged to prompt the user that it is not an appropriate timing to transmit data, and to prompt the user not to remove the mobile phone.

For example, the charging information may be fed back to the terminal equipment by the electronic ink display apparatus. For example, if receiving the charging information indicating that the charging is completed, the terminal equipment outputs the charging completion prompt information. Before receiving the charging information indicating that the charging is completed, the terminal equipment outputs the prompt information indicating that the apparatus is being charged.

In S104, the terminal equipment receives a data update instruction and sends the target update content to the electronic ink display apparatus.

For example, the terminal equipment may receive the data update instruction from the user, and send the target update content to the electronic ink display apparatus in response to the received data update instruction. The control method of the electronic ink display apparatus may be achieved by means of the APP installed in the terminal equipment, and the target update content may be sent by means of a data update control in the APP (e.g., a data update instruction button). For example, referring to FIG. 10, the user may click a button of “Start transmission” on the fourth interface to start sending the target update content.

For example, sending the target update content to the electronic ink display apparatus includes: sending the target update content to the electronic ink display apparatus through an NFC technology. The target update content may be sent to the electronic ink display apparatus according to the identification of the electronic ink display apparatus. After the user selects an identification, the first NFC module of the terminal equipment establishes an communication connection with an electronic ink display apparatus with the identification selected by the user through the NFC technology, and correspondingly, the target update content will also be sent to the electronic ink display apparatus by the first NFC module of the terminal equipment based on the NFC technology, and be received by the second NFC module of the electronic ink display apparatus. For the terminal equipment and the electronic ink display apparatus, the charging function and the data transmission function may be achieved through respective NFC modules, which is a double advantage.

For example, receiving the data update instruction includes: receiving a click instruction of a data update button displayed on the terminal equipment; and if the charging state prompt information is configured to prompt that the charging of the electronic ink display apparatus is completed, recognizing the click instruction as the data update instruction. In addition, if the charging state prompt information is configured to prompt that the charging of the electronic ink display apparatus is not completed, the click instruction is not recognized as the data update instruction. For example, referring to FIG. 9, when the third interface displayed on the terminal equipment includes the words of “The device is being charged . . . ”, the button of “Start transmission” on the third interface (i.e., the data update button) is grayed out. In this case, if the user wants to send the data update instruction to the electronic ink display apparatus, the terminal equipment will not make a response to the data update instruction (i.e., the clicking of the gray button of “Start transmission”) even if the user clicks the button. For another example, referring to FIG. 10, when the fourth interface displayed on the terminal equipment includes the words of “The charging is completed”, the button of “Start transmission” (i.e., the data update button) on the fourth interface is lightened. In this case, the user can click the button to send the data update instruction to the electronic ink display apparatus, and the lighten of the data update button may be regarded as another charging completion information. In this way, when the charging is not completed, even if the user clicks the button of “Start transmission”, the terminal equipment makes no response, thereby preventing a misoperation of the user; when the charging is completed, the button of “Start transmission” is lightened, so that the user can know the progress of the current update process in time, and perform the subsequent processes in time.

For example, the target update content sent by the terminal equipment to the electronic ink display apparatus may be encrypted data content, thereby ensuring that the data is not leaked and improving information security.

In S105 (optionally), the terminal equipment controls a transmission progress of the target update content.

S105 may include at least one of the following steps: receiving a stop transmission instruction to stop sending the target update content to the electronic ink display apparatus and outputting stop transmission prompt information; receiving a retransmission instruction, resending the target update content to the electronic ink display apparatus and outputting retransmission prompt information; and receiving a suspension transmission instruction to suspend the sending of the target update content to the electronic ink display apparatus and outputting suspension transmission prompt information.

For example, referring to FIG. 10, the stop transmission instruction may be sent by clicking a button of “Stop transmission” (which is lightened after the charging is completed) on the fourth interface displayed on the terminal equipment, and the stop transmission prompt information may be represented as the highlighted button of “Stop transmission” on the first display device of the terminal equipment, as words of “The transmission is stopped” displayed on the first display device of the terminal equipment, or the like. The retransmission instruction may be sent by clicking a button of “Retransmit” (which is lightened after the charging is completed) on the fourth interface, and the retransmission prompt information may be represented as the highlighted button of “Retransmit” on the first display device of the terminal equipment, as a word of “Retransmitted” on the first display device of the terminal equipment, or the like. The suspension transmission instruction may be sent by clicking a button of “Suspend transmission” (which is lightened after the charging is completed) on the fourth interface, and the suspension transmission prompt information may be represented as the highlighted button of “Suspend transmission” on the first display device of the terminal equipment, as words of “The transmission is suspended” on the first display device of the terminal equipment, or the like. In this way, the user can intervene in the update process no matter how far it goes, and know the current situation according to update state prompt information output by the terminal equipment, which facilitates the use process.

In some embodiments, the control method of the electronic ink display apparatus may further include: outputting transmission completion prompt information in response to the completion of the transmission of the target update content, thereby prompting the user that the data transmission is completed, and the electronic ink screen to be updated currently will refresh data according to the target update content. Optionally, “in response to the completion of the transmission of the target update content” may be receiving a transmission completion message fed back by the electronic ink screen.

For example, referring to FIG. 10, a progress bar in the fourth interface on the terminal equipment may be regarded as transmission progress prompt information. When transmission of content to be displayed on the electronic ink display apparatus has not been completed, a percentage value showed by the progress bar is less than 100%. When the transmission is completed, the percentage value showed by the progress bar is 100%. The output of the transmission progress prompt information may make the user know the current update progress and better control the update process, thereby making information interaction timely.

In S106, the terminal equipment outputs the update state prompt information according to the update state of the electronic ink display apparatus.

For example, the terminal equipment determines the update state of the electronic ink display apparatus, and outputs corresponding update state prompt information according to the update state.

S106 may include: outputting, by the terminal equipment, update completion prompt information in response to the completion of the update of the electronic ink display apparatus. The update state prompt information may be represented as a percentage of the update progress, or words of “The update has not been completed” or “The update is completed”, which is not limited here.

In some embodiments, the control method of the electronic ink display apparatus further includes: after the transmission of the target update content is completed and before the update of the electronic ink display apparatus is completed, outputting update incompletion prompt information, and charging the electronic ink display apparatus. For example, the terminal equipment outputs the update incompletion prompt information in response to the incompletion of the update of the electronic ink display apparatus to prompt the user that the electronic ink screen is refreshing data, and still needs to be charged by the terminal equipment. By outputting the update incompletion prompt information, the user is prompted not to take the terminal equipment away, thus preventing the update failure. Optionally, “in response to the incompletion of the update of the electronic ink display apparatus” may be failing to receive an update completion message fed back by the electronic ink display apparatus.

Optionally, the transmission completion prompt information and the update incompletion prompt information may be the same prompt information, which is used to prompt the user that the transmission is completed and at the same time prompt the user that the update is not completed, so that the user should not remove the terminal equipment.

In some other embodiments, in the control method of the electronic ink display apparatus, after the target update content is obtained, and before S106, the target update content may also be displayed on the first display device of the terminal equipment. For example, the third interface in FIG. 9 and the fourth interface in FIG. 10 always display the target update content. The control method of the electronic ink display apparatus may further include receiving an instruction of replacing the target update content, and obtaining and displaying the replaced target update content, so that the user can replace the target update content. Optionally, the replacement instruction may be sent by clicking the target update content displayed on the display screen.

In yet some other embodiments, the control method of the electronic ink display apparatus may further include: obtaining the information about the connection between the terminal equipment and the electronic ink display apparatus. For example, the terminal equipment may detect a state of the connection between itself and the electronic ink display apparatus to obtain the information about the connection. For another example, the terminal equipment may receive the information about the connection fed back by the electronic ink display apparatus. Subsequently, the terminal equipment outputs the connection state prompt information according to the information about the connection.

For example, in response to disconnecting from the electronic ink display apparatus, disconnection prompt information is output. For example, the terminal equipment checks whether it is connected to the electronic ink display apparatus in real time, and prompts the connection state. When the connection therebetween is disconnected, the terminal equipment prompts the user that the connection is to disconnected, so that the user can check the state of the apparatus in time.

In the control method of the electronic ink display apparatus provided by the above embodiments of the present disclosure, the electronic ink display apparatus is charged first and then the charge completion prompt information is displayed when the charging is completed, so that the user is prompted to update the display content. Then, update data is transmitted to the electronic ink display apparatus according to the data update instruction, and the update completion prompt information is displayed after the update is completed, so that the user is prompted that the update is completed. Therefore, the user knows that the terminal equipment can be removed. In the entire update process, the user is prompted at key time points, so that the user can efficiently and flexibly charge the electronic ink display apparatus and precisely control the update of information. As a result, an operation process is optimized, and an update efficiency of electronic ink display apparatus is improved.

In addition, the electronic ink display apparatus does not need to consume power during display. When data of the electronic ink display apparatus is updated, the terminal equipment charges the electronic ink display apparatus, so that the update may be completed, which makes the electronic ink display apparatus need not to be powered by an external power supply. Therefore, it is ensured that the electronic ink display apparatus has sufficient voltage when transmitting and refreshing data.

It will be noted that, in one or more embodiments of the present disclosure, the output of the prompt information is achieved in a form of display, but it can be understood that the prompt information may be output in other manners, for example, using speakers or headphones to output sound, or using light-emitting diode (LED) lights to emit light of different colors, which are both possible ways to output the prompt information. Therefore, the output of the prompt information is not limited to the display output, and may be completed in any one or more forms as needed.

It will be noted that the control method of the electronic ink display apparatus in one or more embodiments of the present disclosure may be performed by a single device, such as a computer or a server. The control method in one or more embodiments of the present disclosure may also be applied to a distributed scenario, and is completed through mutual cooperation of a plurality of devices. In this distributed scenario, one of the plurality of devices may only perform one or more steps in the control method provided by one or more embodiments of the present disclosure, and the plurality of devices may interact with each other to complete the control method.

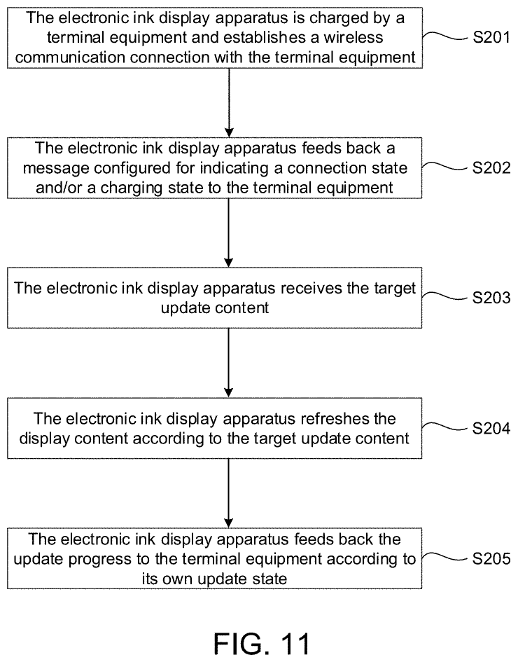

As shown in FIG. 11, some embodiments of the present disclosure further provide an update method of an electronic ink display apparatus, which is applied to the electronic ink display apparatus, and the update method may include the following steps.

In S201, the electronic ink display apparatus is charged by a terminal equipment and establishes a wireless communication connection with the terminal equipment.

For example, the electronic ink display apparatus may be wirelessly charged by the terminal equipment. For example, the electronic ink display apparatus may be charged by the terminal equipment based on an NFC technology. The second NFC module in the electronic ink display apparatus shown in FIG. 5 can convert the magnetic field (e.g., the radio frequency field) generated by the terminal equipment into a power supply required for the internal circuits of the electronic ink display apparatus, and store the obtained amount of electricity in the energy storage device to provide power for the subsequent update process.

In some embodiments, the electronic ink display apparatus is wirelessly charged to using a wireless field provided by the terminal equipment after entering the wireless field provided by the terminal equipment. At the same time when the charging is started, or after the charging is started and before the charging is completed, or after the charging is completed, the electronic ink display apparatus establishes a wireless communication connection with the terminal equipment.

For example, the first NFC module of the terminal equipment generates a magnetic field. When the distance between the electronic ink display apparatus and the terminal equipment is close, e.g., less than 10 cm, the second NFC module in the electronic ink display apparatus can enter the magnetic field and receive the magnetic field to charge itself.

In some other embodiments, after entering the wireless field provided by the terminal equipment, in response to the wireless communication connection established between the electronic ink display apparatus and the terminal equipment, the electronic ink display apparatus is wirelessly charged using the wireless field provided by the terminal equipment.

Firstly, the electronic ink display apparatus establishes the wireless communication connection with the terminal equipment. For example, the electronic ink display apparatus may establish the wireless communication connection with the terminal equipment based on the NFC technology. An establishment process of the wireless communication connection has been described in the foregoing embodiments, which will not be repeated here.

Secondly, after establishing the wireless communication connection with the terminal equipment, the electronic ink display apparatus is wirelessly charged using the wireless field provided by the terminal equipment.

For example, the second NFC module in the electronic ink display apparatus includes an NFC chip and an NFC coil. The NFC coil is configured to be applied to the step of establishing the wireless communication connection with the terminal equipment, and then be applied to the step of the wireless charging.

In yet some other embodiments, the update method of the electronic ink display apparatus may further include: feeding back the connection state information to the terminal equipment, and feeding back a connection success message to the terminal equipment in response to the establishment of the wireless communication connection with the terminal equipment. The electronic ink display apparatus may feed back the connection state information to the terminal equipment through the NFC antenna coil. After receiving the connection state information fed back by the electronic ink display apparatus, the terminal equipment will output corresponding connection state prompt information, so that the user can better know the current state of the update process of the electronic ink display apparatus.

In S202 (optionally), the electronic ink display apparatus feeds back a message configured for indicating a connection state and/or a charging state to the terminal equipment.

In this way, the terminal equipment can output, based on the message indicating the connection state and/or the charging state, corresponding prompts to the user, so that the user can better know the current state of the update process of the electronic ink display apparatus.

S202 may include at least one of the following steps.

In step 1, the electronic ink display apparatus feeds back connection information to the terminal equipment.

For example, after establishing the wireless communication connection with the terminal equipment, the electronic ink display apparatus may periodically detect the connection state therebetween to determine whether the communication connection therebetween is interrupted, and send the connection information indicating the connection state to the terminal equipment. Moreover, in response to the establishment of the connection to the terminal equipment, the electronic ink display apparatus feeds back a connection success message to the terminal equipment. Before the connection is successfully established, no connection information is sent to the terminal equipment.

In step 2, after establishing the wireless communication connection with the terminal equipment, the electronic ink display apparatus feeds back charging information to the terminal equipment.

For example, the electronic ink display apparatus checks the amount of electricity of the energy storage device. When the amount of electricity of the energy storage device is not less than the rated amount of electricity, it indicates that the charging is completed; otherwise, it indicates that the charging is not completed. The electronic ink display apparatus feeds back a charging completion message to the terminal equipment in response to the completion of charging. The electronic ink display apparatus feeds back a charging incompletion message to the terminal equipment in response to the incompletion of charging. Alternatively, if the electronic ink display apparatus does not feed back the charging completion message to the terminal equipment, it means that the charging is not completed. In this way, according to the received charging information fed back by the electronic ink display apparatus, the terminal equipment outputs corresponding charging state prompt information.

In S203, the electronic ink display apparatus receives the target update content.

After the electronic ink display apparatus establishes the wireless communication connection with the terminal equipment and the charging of the electronic ink display apparatus is completed, the electronic ink display apparatus receives the target update content sent by terminal equipment. An amount of electricity stored when the charging is completed may be greater than or equal to an amount of electricity required for the electronic ink display apparatus from starting to operate to successfully receiving the target update content sent by the terminal equipment.

For example, the electronic ink display apparatus receives the target update content based on the NFC technology. A data interaction process between the electronic ink display apparatus and the terminal equipment has been described in the foregoing embodiments, which will not be repeated here.

In S204, the electronic ink display apparatus refreshes the display content according to the target update content.

For example, referring to FIG. 5, in the electronic ink display apparatus, the second processor 120 obtains the target update content through the second NFC module, and then controls the display device 130 to display the target update content.

In S205 (optionally), the electronic ink display apparatus feeds back the update progress to the terminal equipment according to its own update state.

For example, in response to the completion of the update, the electronic ink display apparatus feeds back the update completion message to the terminal equipment. For example, the electronic ink display apparatus may feed back the update progress to the terminal equipment. After receiving the update progress fed back by the electronic ink display apparatus, the terminal equipment may output the update state prompt information in a form of a progress bar on the display interface.

In yet some other embodiments, the update method of the electronic ink display apparatus further includes at least one of the following steps:

in response to a data update failure, feeding back a data update failure message to the terminal equipment;

in response to a data transmission failure, feeding back a data transmission failure message to the terminal equipment.

In this way, the user may know the situation of the data transmission failure and/or the data update failure in time, so as to solve the problem as soon as possible.

Referring to FIG. 2, embodiments of the present disclosure provide a terminal equipment, which includes the memory 320 and the processor 310. The memory 320 stores computer programs therein, and the processor 310 is configured to run the computer programs, so that the terminal equipment performs the control method of the electronic ink display apparatus as described in any of the above embodiments.

Referring to FIG. 3, embodiments of the present disclosure provide a terminal equipment 200, which include a first charging and communication device 210, a first processor 220, and an output device 230.

The first charging and communication device 210 is configured to charge an electronic ink display apparatus. The first processor 220 is configured to control the output device 230 to output charging state prompt information. Outputting the charging state prompt information includes: outputting charging completion prompt information in response to a completion of the charging of the electronic ink display apparatus. The first charging and communication device 210 is further configured to receive a data update instruction after the terminal equipment establishes a wireless communication connection with the electronic ink display apparatus. The first processor 220 is further configured to control, in response to the data update instruction, the first charging and communication device to send target update content to the electronic ink display apparatus.

For example, the first charging and communication device 210 may be coupled to the first processor 220, and charge the electronic ink display apparatus and send or receive data (e.g., the target update content or information)/signaling (e.g., instructions) as controlled by the first processor 220.

For example, the output device 230 may be coupled to the first processor 220 and operate as controlled by the first processor 220. For example, the output device 230 may be a display device to present information to be output on the display interface.

In some embodiments, the first charging and communication device 210 is configured to wirelessly charge the electronic ink display apparatus in response to the establishment of the wireless communication connection between the terminal equipment and the electronic ink display apparatus. Alternatively, the first charging and communication device 210 is configured to wirelessly charge the electronic ink display apparatus in response to the electronic ink display apparatus entering the wireless field provided by the terminal equipment.

In some embodiments, the first charging and communication device 210 is configured to obtain the charging information of the electronic ink display apparatus. The first processor 220 is further configured to control, according to the charging information, the output device 230 to output the charging state prompt information.

In some embodiments, the first charging and communication device 210 is configured to receive the click instruction of the data update button displayed on the terminal equipment, and recognize the click instruction as the data update instruction if the charging state prompt information is configured to prompt that the charging of the electronic ink display apparatus is completed. If the charging state prompt information is configured to prompt that the charging of the electronic ink display apparatus is not completed, the click instruction is not recognized as the data update instruction.

In some embodiments, the first charging and communication device 210 is configured to charge the electronic ink display apparatus through an NFC technology. The first charging and communication device 210 is configured to send the target update content to the electronic ink display apparatus through another NFC technology.

In some embodiments, the first charging and communication device 210 is configured to obtain the identification of the electronic ink display apparatus. The first processor 220 is configured to control the first charging and communication device 210 to send the target update content to the electronic ink display apparatus according to the identification of the electronic ink display apparatus.

In some embodiments, the first charging and communication device 210 is further configured to receive the stop transmission instruction, and the first processor 220 is further configured to stop sending the target update content to the electronic ink display apparatus and control the output device 230 to output the stop transmission prompt information.

In some embodiments, the first charging and communication device 210 is further configured to receive the retransmission instruction, and the first processor 220 is further configured to resend the target update content to the electronic ink display apparatus and control the output device 230 to output the retransmission prompt information.

In some embodiments, the first charging and communication device 210 is further configured to receive the suspension transmission instruction, and the first processor 220 is further configured to suspend the sending of the target update content to the electronic ink display apparatus and control the output device 230 to output the suspension transmission prompt information.

In some embodiments, the first processor 220 is further configured to: control the output device 230 to output the update incompletion prompt information after the transmission of the target update content is completed and before the update of the electronic ink display apparatus is completed; and charge the electronic ink display apparatus.

In some embodiments, the first processor 220 is further configured to control the output device 230 to output the update completion prompt information in response to the completion of the update of the electronic ink display apparatus.

In some embodiments, the first charging and communication device 210 is further configured to obtain the information about the connection between the terminal equipment and the electronic ink display apparatus. The first processor 220 is further configured to control, according to the connection information, the output device 230 to output the connection state prompt information.

In some embodiments, the first charging and communication device 210 is further configured to receive an instruction for a connection to the electronic ink display apparatus. The first processor 220 is further configured to scan electronic ink display apparatus(es) within the predetermined range, and establish the wireless communication connection with at least one electronic ink display apparatus within the predetermined range.

Referring to FIG. 2, embodiments of the present disclosure provide an electronic ink display apparatus, which includes the memory 320 and the processor 310. The memory 320 stores computer programs, and the processor 310 is configured to run the computer programs, so that the electronic ink display apparatus performs the update method of the electronic ink display apparatus as described in any of the above embodiments.

Referring to FIG. 5, some embodiments of the present disclosure provide an electronic ink display apparatus 100, which includes a second charging and communication device 110, a second processor 120, and a display device 130.

The second charging and communication device 110 is configured to be charged through a terminal equipment, and receive target update content sent by the terminal equipment after the electronic ink display apparatus establishes a wireless communication connection with the terminal equipment and the charging of the electronic ink display apparatus is completed.

The display device 130 may be coupled to the second processor 120, and the second processor 120 is configured to control the display device 130 to refresh the display content according to the target update content.

For example, the second charging and communication device 110 may be coupled to the second processor 120, and perform charging and send or receive the data (e.g., the target update content or information)/signaling (e.g., the instructions) as controlled by the second processor 120.

In some embodiments, the second processor 120 is further configured to control the second charging and communication device 110 to feed back the connection information to the terminal equipment.

In some embodiments, the second processor 120 is further configured to control the second charging and communication device 110 to feed back the charging information to the terminal equipment after the electronic ink display apparatus establishes the wireless communication connection with the terminal equipment.

In some embodiments, the second processor 120 is configured to control the second charging and communication device 110 to feed back the charging completion message to the terminal equipment in response to the completion of the charging of the electronic ink display apparatus, after the electronic ink display apparatus establishes the wireless communication connection with the terminal equipment.

In some embodiments, the second processor 120 is configured to control the second charging and communication device 110 to feed back the connection success message to the terminal equipment in response to establishing the connection with the terminal equipment.

In some embodiments, the second processor 120 is configured to in response to the establishment of the wireless communication connection between the electronic ink display apparatus and the terminal equipment, control the second charging and communication device 110 to perform the wireless charging through the wireless field provided by the terminal equipment, after entering the wireless field provided by the terminal equipment. Alternatively, the second processor 120 is configured to control the second charging and communication device 110 to perform the wireless charging through the wireless field provided by the terminal equipment, after entering the wireless field provided by the terminal equipment.

In some embodiments, the second charging and communication device 110 is configured to perform charging through the terminal equipment based on an NFC technology.

In some embodiments, the second charging and communication device 110 is configured to receive the target update content sent by the terminal equipment based on another NFC technology.

In some embodiments, in response to the completion of the update, the second processor 120 controls the second charging and communication device 110 to feed back the update completion message to the terminal equipment.

The electronic ink display apparatus provided by the embodiments of the present disclosure feeds back corresponding messages to the terminal equipment at key time points, so that the terminal equipment may perform corresponding processes, and can better complete the data update of the electronic ink display apparatus, thereby improving the data update efficiency.

For convenience of description, when describing the above device (the terminal equipment or the electronic ink display apparatus), descriptions are made on the basis of functions of the components. Of course, when implementing one or more embodiments of the present disclosure, the functions of the components may be implemented in the same one or more software and/or hardware.

The device (the terminal equipment or the electronic ink display apparatus) of the foregoing embodiments is used to implement corresponding method in one or more of the foregoing embodiments, and has beneficial effects as those in the corresponding method embodiments, which will not be repeated here.

Embodiments of the present disclosure further provide an update system of an electronic ink display apparatus, which includes the terminal equipment as described in any of the above embodiments, and the electronic ink display apparatus as described in any of the above embodiments.

Embodiments of the present disclosure further provide a computer-readable storage medium. The computer-readable storage medium stores therein computer program instructions that, when executed on a computer, cause the computer to perform the control method of the electronic ink display apparatus as described in any of the above embodiments or perform the update method of the electronic ink display apparatus as described in any of the above embodiments. For example, when executed on the terminal equipment, the computer program instructions cause the terminal equipment to perform the control method of the electronic ink display apparatus as described in any of the above embodiments. For another example, when executed on the electronic ink display apparatus, the computer program instructions cause the electronic ink display apparatus to perform the update method of the electronic ink display apparatus as described in any of the above embodiments.

For example, the computer-readable storage medium may include, but is not limited to, a magnetic storage device (for example, a hard disk, a floppy disk or a magnetic tape), an optical disk (e.g., a compact disk (CD)), a digital versatile disk (DVD), a smart card, a flash memory device (e.g., an erasable programmable read-only memory (EPROM)), a card, a stick or a key driver. Various computer-readable storage media described in the present disclosure may represent one or more devices and/or other machine-readable storage media for storing information. The term “machine-readable storage media” may include, but are not limited to, wireless channels and various other media capable of storing, containing and/or carrying instructions and/or data.

The embodiments of the present disclosure further provide a computer program product. The computer program product includes computer program instructions that, when executed on a computer, cause the computer to perform the control method of the electronic ink display apparatus as described in any of the above embodiments or perform the update method of the electronic ink display apparatus as described in any of the above embodiments. For example, when executed on the terminal equipment, the computer program instructions cause the terminal equipment to perform the control method of the electronic ink display apparatus as described in any of the above embodiments. For another example, when executed on the electronic ink display apparatus, the computer program instructions cause the electronic ink display apparatus to perform the update method of the electronic ink display apparatus as described in any of the above embodiments.

The embodiments of the present disclosure further provide a computer program. When run on a computer, the computer program causes the computer to perform the control method of the electronic ink display apparatus as described in any of the above embodiments or perform the update method of the electronic ink display apparatus as described in any of the above embodiments.

Beneficial effects of the computer-readable storage medium, the computer program product and the computer program are the same as those of the control method of the electronic ink display apparatus as described in some of the above embodiments, which will not be described in detail herein.

The foregoing descriptions are merely specific implementations of the present disclosure, but the protection scope of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

1. A control method of an electronic ink display apparatus, applied to a terminal equipment, and comprising:
charging the electronic ink display apparatus;
outputting charging state prompt information, wherein outputting the charging state prompt information includes: outputting charging completion prompt information in response to a completion of the charging of the electronic ink display apparatus; and
after the terminal equipment establishes a wireless communication connection with the electronic ink display apparatus, receiving a data update instruction and sending target update content to the electronic ink display apparatus.

2. The control method of the electronic ink display apparatus according to claim 1, wherein charging the electronic ink display apparatus includes:
in response to the establishment of the wireless communication connection of the terminal equipment to the electronic ink display apparatus, wirelessly charging the electronic ink display apparatus;
or,
in response to the electronic ink display apparatus entering a wireless field provided by the terminal equipment, wirelessly charging the electronic ink display apparatus.

3. The control method of the electronic ink display apparatus according to claim 1, further comprising:
obtaining charging information of the electronic ink display apparatus, wherein
outputting the charging state prompt information includes: outputting the charging state prompt information according to the charging information.

4. The control method of the electronic ink display apparatus according to claim 1, wherein receiving the data update instruction includes:
receiving a click instruction of a data update button displayed on the terminal equipment; and
if the charging state prompt information is used for indicating that the charging of electronic ink display apparatus is completed, recognizing the click instruction as the data update instruction; and
the control method of the electronic ink display apparatus further comprising:
if the charging state prompt information is used for indicating that the charging of the electronic ink display apparatus is not completed, not recognizing the click instruction as the data update instruction.

5. The control method of the electronic ink display apparatus according to claim 1, wherein charging the electronic ink display apparatus includes: charging the electronic ink display apparatus through a near field communication technology; and
sending the target update content to the electronic ink display apparatus includes: sending the target update content to the electronic ink display apparatus through another near field communication technology.

6. The control method of the electronic ink display apparatus according to claim 1, further comprising: obtaining an identification of the electronic ink display apparatus; and
sending the target update content to the electronic ink display apparatus includes: sending the target update content to the electronic ink display apparatus according to the identification of the electronic ink display apparatus.

7. The control method of the electronic ink display apparatus according to claim 1, wherein after receiving the data update instruction and sending the target update content to the electronic ink display apparatus, the control method of the electronic ink display apparatus further comprises at least one of:
receiving a stop transmission instruction to stop sending the target update content to the electronic ink display apparatus, and outputting stop transmission prompt information;
receiving a retransmission instruction, resending the target update content to the electronic ink display apparatus, and outputting retransmission prompt information; and
receiving a suspension transmission instruction to suspend the sending of the target update content to the electronic ink display apparatus, and outputting suspension transmission prompt information.

8. The control method of the electronic ink display apparatus according to claim 1, further comprising:
after a transmission of the target update content is completed and before an update of the electronic ink display apparatus is completed, outputting update incompletion prompt information and charging the electronic ink display apparatus.

9. The control method of the electronic ink display apparatus according to claim 1, further comprising:
in response to a completion of an update of the electronic ink display apparatus, outputting update completion prompt information.

10. The control method of the electronic ink display apparatus according to claim 1, further comprising:
obtaining information about the connection between the terminal equipment and the electronic ink display apparatus; and
outputting connection state prompt information according to the information about the connection.

11. The control method of the electronic ink display apparatus according to claim 1, further comprising:
receiving an instruction for a connection to at least one electronic ink display apparatus;
scanning electronic ink display apparatuses within a predetermined range; and
establishing a wireless communication connection with at least one electronic ink display apparatus within the predetermined range.

12. An update method of an electronic ink display apparatus, comprising:
performing charging through a terminal equipment;
after the electronic ink display apparatus establishes a wireless communication connection with the terminal equipment and the charging of the electronic ink display apparatus is completed, receiving target update content sent by the terminal equipment; and
refreshing display content according to the target update content.

13. The update method of the electronic ink display apparatus according to claim 12, further comprising at least one of:
feeding back connection information to the terminal equipment; and
after the electronic ink display apparatus establishes the wireless communication connection with the terminal equipment, feeding back charging information to the terminal equipment.

14. The update method of the electronic ink display apparatus according to claim 13, wherein
after the electronic ink display apparatus establishes the wireless communication connection with the terminal equipment, feeding back the charging information to the terminal equipment includes: after the electronic ink display apparatus establishes the wireless communication connection with the terminal equipment, in response to a completion of the charging of the electronic ink display apparatus, feeding back a charging completion message to the terminal equipment; and
feeding back the connection information to the terminal equipment includes: in response to the establishment of the connection with the terminal equipment, feeding back a connection success message to the terminal equipment.

15. The update method of the electronic ink display apparatus according to claim 12, wherein performing the charging through the terminal equipment includes:
after the electronic ink display apparatus enters a wireless field provided by the terminal equipment, in response to the establishment of the wireless communication connection of the electronic ink display apparatus to the terminal equipment, performing wireless charging through the wireless field provided by the terminal equipment;
or,
after the electronic ink display apparatus enters the wireless field provided by the terminal equipment, performing wireless charging through the wireless field provided by the terminal equipment.

16. The update method of the electronic ink display apparatus according to claim 12, wherein performing the charging through the terminal equipment includes: performing charging through the terminal equipment based on a near field communication technology; and
receiving the target update content sent by the terminal equipment includes: receiving the target update content sent by the terminal equipment based on another near field communication technology.

17. (canceled)

18. A terminal equipment, comprising a first charging and communication device, a first processor, and an output device, wherein
the first charging and communication device is configured to charge an electronic ink display apparatus;
the first processor is configured to control the output device to output charging state prompt information, outputting the charging state prompt information includes: outputting charging completion prompt information in response to a completion of the charging of the electronic ink display apparatus;
the first charging and communication device is further configured to receive a data update instruction after the terminal equipment establishes a wireless communication connection with the electronic ink display apparatus; and
the first processor is further configured to control, in response to the data update instruction, the first charging and communication device to send target update content to the electronic ink display apparatus.

19. An electronic ink display apparatus, comprising a second charging and communication device, a second processor, and a display device that are configured to perform the update method of the electronic ink display apparatus according to claim 12.

20. An update system of an electronic ink display apparatus, comprising:
the terminal equipment according to claim 18; and
the electronic ink display apparatus including a second charging and communication device, a second processor, and a display device; wherein
the second charging and communication device is configured to perform the charging through the terminal equipment, and receive the target update content sent by the terminal equipment after the electronic ink display apparatus establishes the wireless communication connection with the terminal equipment and the charging of the electronic ink display apparatus is completed; and
the second processor is configured to control, according to the target update content, the display device to refresh display content.

21. A non-transitory computer-readable storage medium storing computer program instructions that, when executed on a computer, cause the computer to perform the control method of the electronic ink display apparatus according to claim 1.
